(19) United States
(12) Patent Application Publication
(10) Pub. No.: US 2012/0275839 A1
(43) Pub. Date: Nov. 1, 2012

(54) SHEET STORAGE DEVICE AND IMAGE FORMING APPARATUS

(75) Inventors: Hideki Kushida, Moriya-shi (JP); Naoto Tokuma, Abiko-shi (JP); Daisaku Kamiya, Abiko-shi (JP); Toshiyuki Iwata, Abiko-shi (JP); Toshiki Momoka, Tokyo (JP)

(73) Assignee: CANON KABUSHIKI KAISHA, Tokyo (JP)

(21) Appl. No.: 13/449,764

(22) Filed: Apr. 18, 2012

(30) Foreign Application Priority Data
Apr. 28, 2011 (JP) 2011-101453

(51) Int. Cl. B41J 13/24

(52) U.S. Cl. 400/623

(57) ABSTRACT

A sheet storage device and an image forming apparatus capable of increasing extractability and visibility are provided. A plurality of trays 330 (330a to 330e) receives sheets sequentially conveyed from an image forming apparatus main body 100A from a lower part thereof and stores the sheets in a standing condition. The plurality of trays 330 (330a to 330e) is configured such that a downstream end in a sheet conveying direction and a front end in a direction perpendicular to a sheet conveying direction of the stored sheets protrude from the trays 330 (330a to 330e).

### BACKGROUND OF THE INVENTION

1. Field of the Invention

The present invention relates generally to a sheet storage device and an image forming apparatus and, more particularly, to a sheet storage device disposed on an upper surface of an image forming apparatus main body.

2. Description of the Related Art

In the related art, an image forming apparatus includes a sheet storage device storing sheets discharged from an image forming apparatus main body after images are formed such that sheets on which images are formed are sequentially discharged on the sheet storage device. An example of a sheet storage apparatus is a bin moving type sorter in which a plurality of bins storing sheets discharged after images are formed is provided so as to move in a vertical direction (see U.S. Pat. No. 5,722,030).

FIGS. 24A and 24B are diagrams illustrating a bin moving type sorter of the related art. This sorter 1002 includes a plurality of bin trays Bn which is movable in a vertical direction as illustrated in FIG. 24A. In addition, the plurality of bin trays Bn is moved by one step upward or downward by one revolution of spiral cams (not illustrated) provided at both sides thereof.

In the image forming apparatus main body 1000, a sheet on which an image is formed by a toner is sent to the sorter 1002 through a pair of discharge rollers 1001 and then the sheet is sent selectively to one of a sort path and a non-sort path in a direction switched by a switching member (not illustrated). A sheet passing through the non-sort path is discharged onto a non-sort tray 1003 and a sheet passing through the sort path is discharged by a discharge roller 1004 and is stored on each bin tray Bn elevating in synchronization with ejection.

However, such a sheet storage device of the related art sequentially stores sheets stacked into a flat pile on the bin trays arranged substantially horizontally or in a gently inclined manner. In order to improve an identification property of a discharged sheet, a plurality of bin trays is configured in a stacked structure and the bin trays are changed per job of the discharged sheet. Accordingly, the positions of the bin trays are different in height. In particular, a sheet stored in a bin tray at a lower position may not be seen easily or extracted handily.

In addition, sheet bundles discharged onto the bin trays are not bound to a sheet bundle state, except the case of performing stapling. Accordingly, a sheet bundle may be erroneously brought into contact with another sheet bundle when the sheet bundles are extracted from the bin tray or sheets may be disarranged on the bin tray by a sheet state (curl, surface friction, or the like) at the time of discharge. In this case, as a result, sheets may not be easily extracted or apparatus troubles such as apparatus discharge error may occur. Since the sheet storage device of the related art is disposed at a side of the image forming apparatus, the overall width increases in the system that the image forming apparatus and the sheet storage device are aligned.

In view of the foregoing, the present invention is to provide a sheet storage device and an image forming apparatus capable of improving extractability and visibility.

### SUMMARY OF THE INVENTION

The present invention is a sheet storage device mounted above an image forming apparatus main body to store sheet sequentially conveyed from the image forming apparatus main body. The sheet storage device includes a conveying portion configured to convey the sheet, and a plurality of sheet storage portions configured to receive the sheet conveyed by the conveying portion from a low part thereof, store the sheet in a standing state, each of the plurality of sheet storage portions includes a holding portion configured to hold the sheet so as to permit a sheet passing in a sheet conveying direction, and restrict a movement of the sheet in a direction opposite to the conveying direction, the holding portion holds the sheet such that at least one of a downstream end in the sheet conveying direction and one end in a width perpendicular to the sheet conveying direction of the stored sheet protrudes.

In the present invention, extractability and visibility can be improved by a plurality of sheet storage portions which can store sheets in a standing condition and from which a downstream end in a sheet conveying direction and one end in a width direction of the stored sheets protrude.

Further features of the present invention will become apparent from the following description of exemplary embodiments with reference to the attached drawings.

### BRIEF DESCRIPTION OF THE DRAWINGS

FIG. 1 is a diagram illustrating the configuration of an image forming apparatus including a sheet storage device according to a first embodiment of the present invention;

FIG. 2 is a first diagram illustrating the configuration of the sheet storage device;

FIG. 3 is a second diagram illustrating the configuration of the sheet storage device;

FIG. 4 is a third diagram illustrating the configuration of the sheet storage device;

FIG. 5 is a diagram illustrating the configuration of a holding portion of a tray mounted in the sheet storage device;

FIGS. 6A and 6B are diagrams illustrating an operation of storing and holding a sheet in the holding portion;

FIG. 7 is a perspective view illustrating a state that a sheet is stored and held in the tray;

FIG. 8 is a control block diagram illustrating control of an image forming apparatus main body and the sheet storage device;

FIG. 9 is a control block diagram of a sheet storage device controller controlling the sheet storage device;

FIG. 10 is a flowchart illustrating control of a sheet storage operation of the sheet storage device;

FIG. 11 is a flowchart illustrating a storage target tray number deciding process of the sheet storage device;

FIG. 12 is a flowchart illustrating a process of moving storage portion of the sheet storage device;

FIG. 13 is a diagram illustrating the configuration of an another holding portion of a tray mounted in the sheet storage device;

FIG. 14 is a diagram illustrating the configuration of a sheet storage device according to a second embodiment of the present invention;

FIG. 15 is a second diagram illustrating the configuration of the sheet storage device;

FIGS. 16A and 16B are diagrams illustrating an operation of storing and holding a sheet in a holding portion of a tray mounted in the sheet storage device;

FIG. 17 is a diagram illustrating a state when a sheet is extracted from the holding portion;

FIG. 18 is a block diagram illustrating control of a sheet storage device controller controlling the sheet storage device;

FIG. 19 is a flowchart illustrating sheet storage operation control of the sheet storage device;

FIG. 20 is a flowchart illustrating a tip stopper switching process of the sheet storage device;

FIG. 21 is a flowchart illustrating a sheet extracting process of the sheet storage device;

FIG. 22 is a diagram illustrating the configuration of a sheet storage device according to a third embodiment of the present invention;

FIG. 23 is a perspective view illustrating a state in which a sheet is stored and held in a holding portion of a tray mounted in the sheet storage device; and

FIGS. 24A and 24B are diagrams illustrating the configuration of a sheet storage device of the related art.

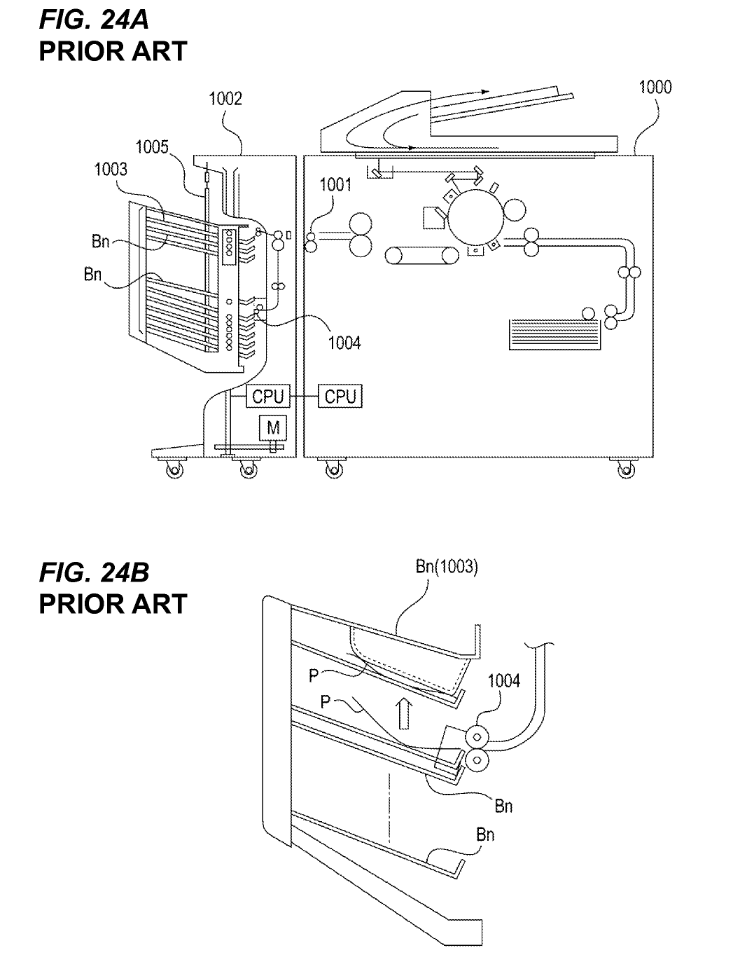

### DESCRIPTION OF THE EMBODIMENTS

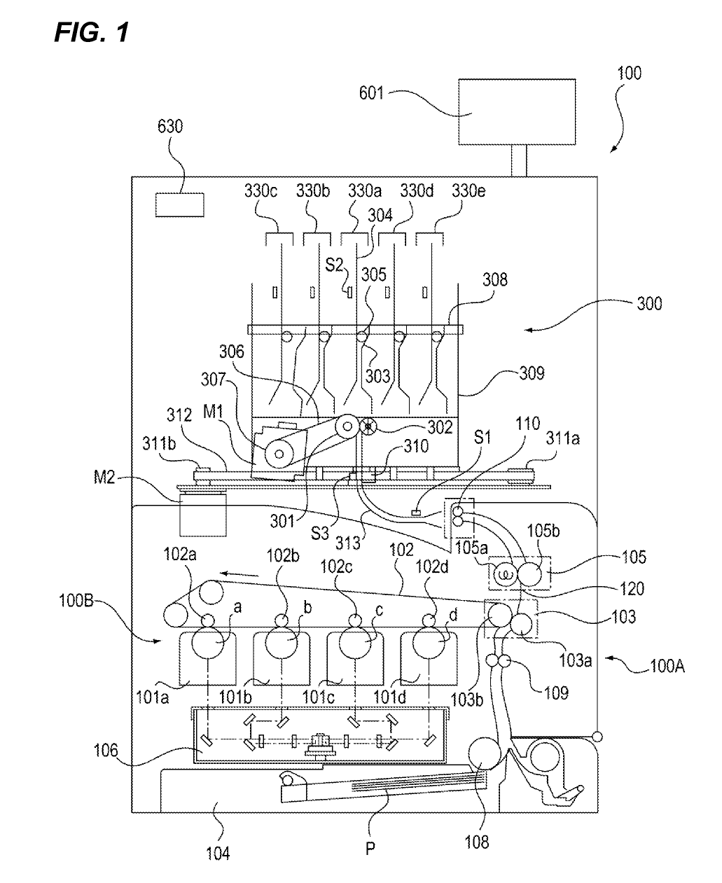

Hereinafter, embodiments of the present invention will be described in detail with respect to the drawings. FIG. 1 is a diagram illustrating the configuration of an image forming apparatus including a sheet storage device according to a first embodiment of the present invention. An image forming apparatus 100 includes an image forming apparatus main body 100A (hereinafter, referred to as an apparatus main body), an image forming portion 100B forming an image on a sheet, and a sheet storage device 300 disposed on an upper surface (upper side) of the apparatus main body 100A.

The image forming portion 100B includes photosensitive drums a to d forming toner images of four colors of yellow, magenta, cyan and black and an exposure device 106 irradiating a laser beam based on image information and forming electrostatic latent images on the photosensitive drums. In addition, the photosensitive drums a to d are driven by motors (not illustrated), a primary charger, a development device and a transfer charger (not illustrated) are arranged in the vicinity of each of the photosensitive drums, and the photosensitive drums are unitized as process cartridges 101a to 101d.

An intermediate transfer belt 102 is rotated and driven in a direction denoted by arrow, and a transfer bias is applied to the intermediate transfer belt 102 by transfer chargers 102a to 102d so as to sequentially multi-transfer toner images of respective colors on the photosensitive drums onto the intermediate transfer belt 102. Accordingly, a full-color image is formed on the intermediate transfer belt.

A secondary transfer portion 103 sequentially transfers the full-color image formed on the intermediate transfer belt 102 onto a sheet P. This secondary transfer portion 103 includes a secondary transfer counter roller 103b supporting the intermediate transfer belt 102 and a secondary transfer roller 103a which abuts on the secondary transfer counter roller 103b with the intermediate transfer belt 102 interposed therebetween. A registration roller 109 and a sheet feeding cassette 104 are included, and a pickup roller 108 feeds the sheet P received in the sheet feeding cassette 104. A CPU circuit portion 630 is a controller controlling the apparatus main body 100A and the sheet storage device 300.

Next, an image forming operation of the image forming apparatus 100 having the above-described configuration will be described. If the image forming operation is started, first, the exposure device 106 irradiates a laser beam based on image information from a PC (not illustrated), sequentially exposes the surfaces of the photosensitive drums a to d uniformly charged with a predetermined polarity potential, and forms electrostatic latent images on the photosensitive drums a to d. Thereafter, these electrostatic latent images are developed by toners to be visible.

For example, first, a laser beam according to an image signal of a yellow component color of an original is irradiated onto the photosensitive drum a through a polygon mirror of the exposure device 106 so as to form a yellow electrostatic latent image on the photosensitive drum a. Then, the yellow electrostatic latent image is developed by a yellow toner from a development device to be visible as a yellow toner image. Thereafter, this toner image arrives at the primary transfer portion, in which the photosensitive drum a and the intermediate transfer belt 102 abut on each other, according to the rotation of the photosensitive drum a. If the toner image arrive at the primary transfer portion, the yellow toner image on the photosensitive drum a is transferred onto the intermediate transfer belt 102 (primary transfer) by a primary transfer bias applied to the transfer charger 102a.

Next, when a portion containing the yellow toner image of the intermediate transfer belt 102 moves, a magenta toner image formed on the photosensitive drum b is transferred onto the intermediate transfer belt 102 to overlap the yellow toner image using the same method as the above method. Similarly, when the intermediate transfer belt 102 is moved, a cyan toner image and a black toner image are transferred to overlap the yellow toner image and the magenta toner image in the primary transfer portion. Accordingly, a full-color toner image is formed on the intermediate transfer belt 102.

The sheet P received in the sheet feeding cassette 104 is delivered by the pickup roller 108 one by one in parallel to the toner image forming operation. Then, the sheet P reaches the registration roller 109 and is conveyed to the secondary transfer portion 103 after timing is matched by the registration roller 109. Thereafter, in the secondary transfer portion 103, the toner image of four colors on the intermediate transfer belt 102 is collectively transferred onto the sheet P by a secondary transfer bias applied to the secondary transfer roller 103a which is a transfer portion (secondary transfer).

Next, the sheet P onto which the toner image is transferred is conveyed from the secondary transfer portion 103 to a fixing portion 105. By a heating roller 105a and a pressurization roller 105b mounted in the fixing portion 105, the toners of respective colors are melted and mixed by heat and pressure to be fixed on the sheet P as a full-color image. Thereafter, the sheet P on which the image is fixed is ejected by a pair of discharge rollers 110 mounted at the downstream side of the fixing portion 105 and is conveyed to the sheet storage device 300 arranged on the upper surface of the apparatus main body 100A through a conveying guide 313 having a curved shape.

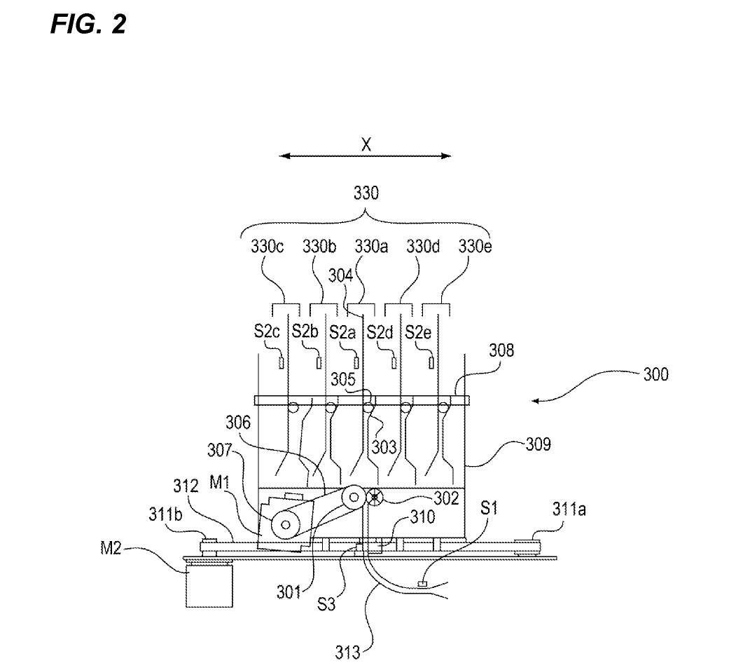

The sheet storage device 300 receives the sheets sequentially conveyed from the apparatus main body 100A from the lower part thereof and stores the sheet in a standing condition. Then, as illustrated in FIG. 2, the sheet storage device 300 includes trays 330 (330a to 330e) which are a plurality (in the present embodiment, 5) of sheet storage portions arranged along a horizontal direction so that sheet storage portions can store the sheets in a standing condition. In addition, since the five trays 330 are arranged above the apparatus main body 100A, it is possible to increase storage amount without increasing a mounting space. Since the sheet is stored in a standing state, a device mounting space does not increase even when a sheet having a large size is received.

In addition, the conveying guide 313 conveying the sheet ejected from the apparatus main body 100A to the trays 330 is included. On the downstream side in the sheet conveying direction of the conveying guide 313, a conveying roller 301 and a driven roller 302 which is pressed to the conveying roller 301 are mounted such that the sheet P is selectively conveyed to one of the five trays 330 by the conveying roller 301 and the driven roller 302 as a conveying portion.

In addition, the conveying roller 301 is rotated and driven by a conveying roller driving gear 307 drive by a conveying motor M1 and a driving belt 306. The sheet storage device 300 includes an inlet sensor S1 mounted on an inlet of the conveying guide 313 and monitors conveying timing of the sheet P from the apparatus main body 100A by the inlet sensor S1.

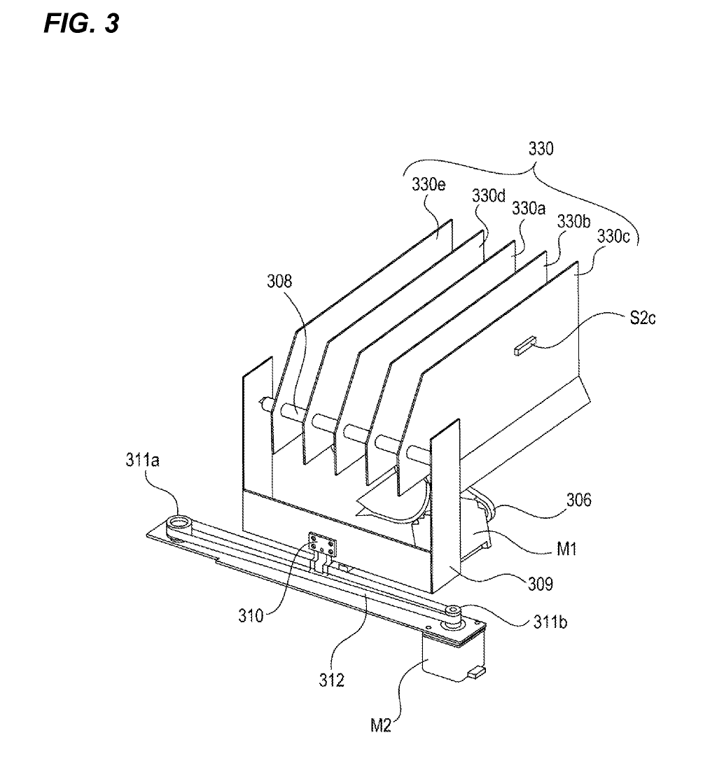

The trays 330 (330a to 330e) are connected by a connection shaft 308 and are held by a holding plate 309 as illustrated in FIG. 3. A connection member 310 fixed to a timing belt 312 stretched over a movement pulley 311b provided on the same shaft as a moving motor M2 and a movement pulley 311a mounted at a counter side thereof is fixed to the holding plate 309.

When the timing belt 312 is rotated, the holding plate 309 is moved along with the connection member 310 and thus the trays 330 are also integrally moved in an X direction (horizontal direction) denoted by arrow illustrated in FIG. 2. Since the trays 330 are moved in the horizontal direction, the tray 330 facing the conveying roller 301 can be changed. Therefore, the sheet P conveyed from the conveying roller 301 can be distinguishably stored in each of the five trays 330.

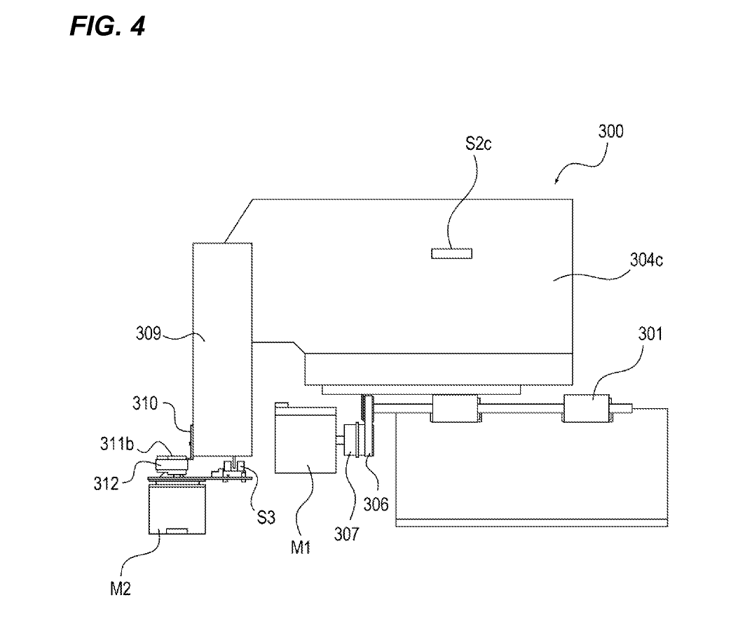

In addition, in the sheet storage device 300, as illustrated in FIG. 4, a detection sensor S3 detecting a home position of the connection member 310 is mounted. By the detection sensor S3, transmission/reception positions of the trays 330 are determined by the home position of the center portion of the trays 330 in the X direction (horizontal direction) illustrated in FIG. 2 and a driving pulse number of the moving motor M2 from the home position.

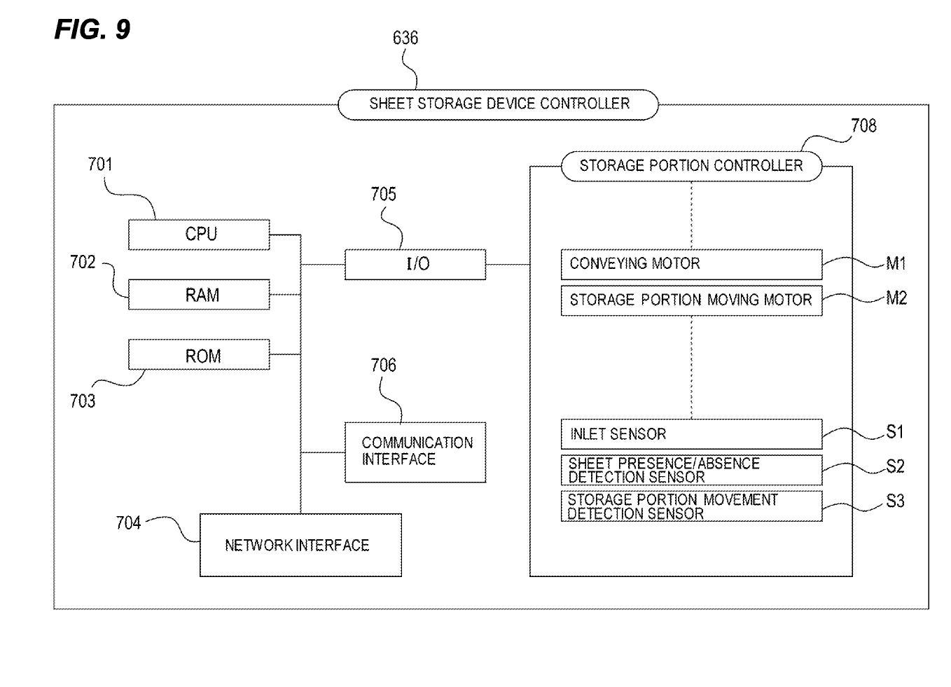

In the trays 330, as illustrated in FIG. 2, detection sensors S2 (S2a to S2e) detecting presence/absence of sheet are mounted. By the detection sensors S2, a determination as to whether the sheet is stored in each of the trays 330 is detected, and the CPU 701 of the below-described sheet storage device controller 636 illustrated in FIG. 9 controls the positions of the trays 330 such that a next ejected sheet P is stored in a tray in which the sheet is not stored.

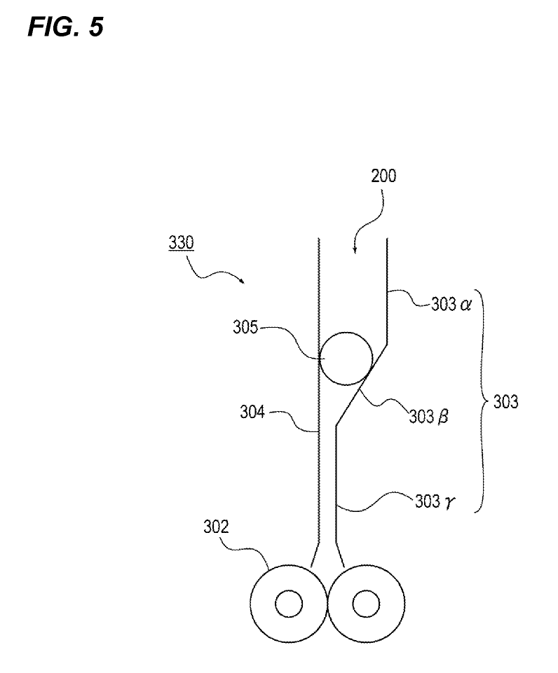

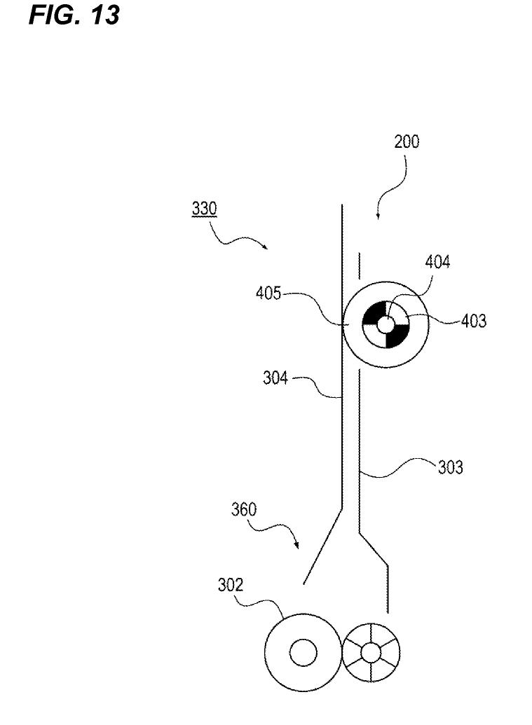

FIG. 5 is a diagram illustrating the configuration of a holding portion 200 receiving the sheet of the tray 330 from the lower part thereof and holds the sheet in a standing condition. The holding portion 200 includes a substantially vertical storage guide 304, a conveying guide 303 mounted to face the storage guide 304, and a columnar holding member 305 interposed between the storage guide 304 and the conveying guide 303 to nip the sheet with the storage guide 304. Although a columnar member is used as the holding member 305 in the present embodiment, a spherical shape, a cylindrical shape, a spindle shape or the like may be used. Further, as illustrated in FIG. 13, a fixed shaft 404 may be provided on the conveying guide 303, and a sponge roller 405 may be also provided on the fixed shaft 404 as the holding member with a one-way clutch 403 interposed therebetween. The sponge roller 405 is configured with an elastic foam, and is provided to abut on the storage guide 304 in an elastically deformed state. The one-way clutch 403 is freely rotatable in the clockwise direction in FIG. 13. However, the one-way clutch 403 follows the fixed shaft 404 in the counterclockwise direction and so is configured not to rotate in the counterclockwise direction. In other words, the sponge roller 405 in which the one-way clutch 403 is incorporated rotates to follow the sheet conveyed to the sheet storage portion 330 by the conveying roller 301 and the driven roller 302 which function as the sheet conveying portion. Meanwhile, sheet movement in a direction opposite to the sheet conveying direction is restricted by pressing force of the sponge roller 405 which is generated between the storage guide 304 and the sponge roller 405, and so the sheet is held against a weight thereof.

The storage guide 304 which is a first guide member forms a sidewall of the holding portion 200 and guides an upper side of the sheet conveyed from the lower part thereof. The conveying guide 303 which is a second guide member includes a counter wall part 303α mounted on an upper part thereof and a lower guide part 303γ mounted on a lower part thereof to guide the sheet upward along with the storage guide 304. In addition, the conveying guide 303 has an inclination part 303β mounted between the upper side of the lower guide part 303γ, that is, the counter wall part 303α, and the lower guide part 303γ and inclined in a direction distant from the storage guide 304.

The holding member 305 is movably mounted between the storage guide 304 and the counter wall part 303α and the inclination part 303β of the conveying guide 303. The holding member 305 abuts on the storage guide 304 and the inclination part 303β of the conveying guide 303 by the weight thereof until the sheet is conveyed to the holding portion 200.

The holding member 305 may be freely moved in a direction in which a distance between the guides increases, that is, upward, but may not be moved in a direction in which the distance between the guides decreases, that is, downward. In other words, the holding portion 200 holds the sheet so as to permit a sheet passing in a sheet conveying direction, and restrict a movement of the sheet in a direction opposite to the conveying direction. An engaging part (not illustrated) is mounted in one of the conveying guide 303 and the storage guide 304 in a range of not impeding the carrying-in the sheet P such that the holding member 305 is not moved and dropped out in the front depth direction perpendicular to the sheet conveying direction.

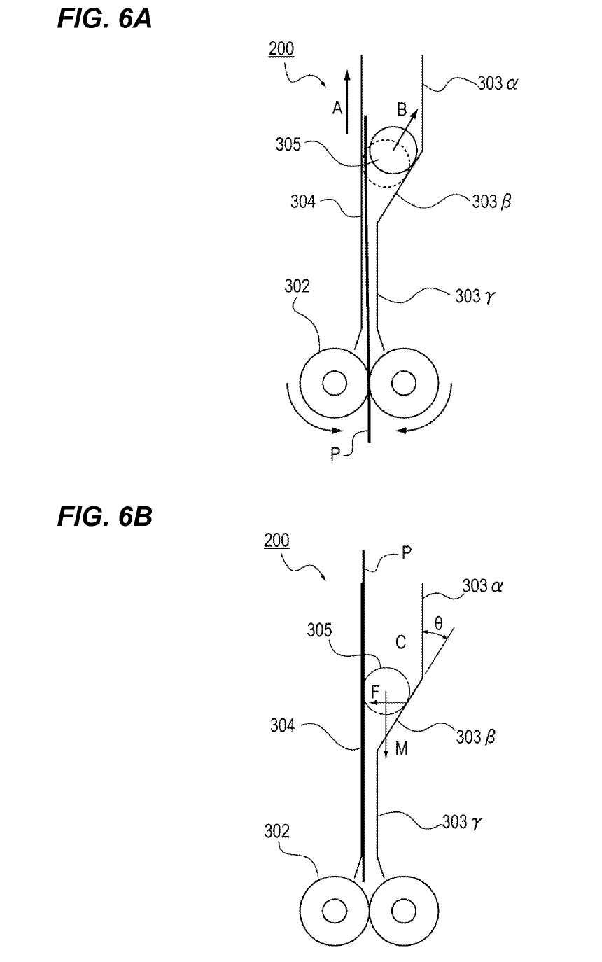

Next, an operation of storing and holding the sheet P in the holding portion 200 of the tray 330 will be described with reference to FIG. 6. As illustrated in FIG. 6A, when the sheet P is conveyed to the tray 330 by the conveying roller 301, the holding member 305 is moved by the thickness of the sheet P in a direction denoted by arrow B along the sheet P while being pressed by the sheet P passing through a nip part with the storage guide 304. In addition, in the present embodiment, the holding member 305 is formed on a lightweight material which can be moved in the direction denoted by arrow B by the conveyed sheet P when the sheet P passing through the nip part between the storage guide 304 and the holding member 305. Accordingly, the sheet P can be stored in the holding portion 200 while moving the holding member 305 upward using weak force in the direction denoted by arrow B.

When the back end of the sheet P escapes from the driven roller 302, as illustrated in FIG. 6B, abutting force F (=M/tan θ) is applied to the sheet P in the direction of the storage guide 304 by gravity M applied to the holding member 305 located on the inclination part 303β. That is, when the back end of the sheet P escapes from the driven roller 302 to release pressure applied to the sheet, the holding member 305 generates a wedge effect with respect to the sheet P. Then, the sheet P is held in the holding portion 200 by the abutting force F acting as the wedge effect.

Thereafter, a subsequent sheet is conveyed between the storage guide 304 and the conveying guide 303 similarly to the preceding sheet P which is held by the storage guide 304 and the holding member 305. Thereafter, by the holding member 305 and entrance of the preceding sheet P into the nip part, the subsequent sheet can be also held by the storage guide 304 and the holding member 305 by the abutting force F while the preceding sheet P is held in the storage guide 304. A series of operations is repeatedly performed with respect to the sequentially conveyed sheets P so as to store a plurality of sheets in the trays 330.

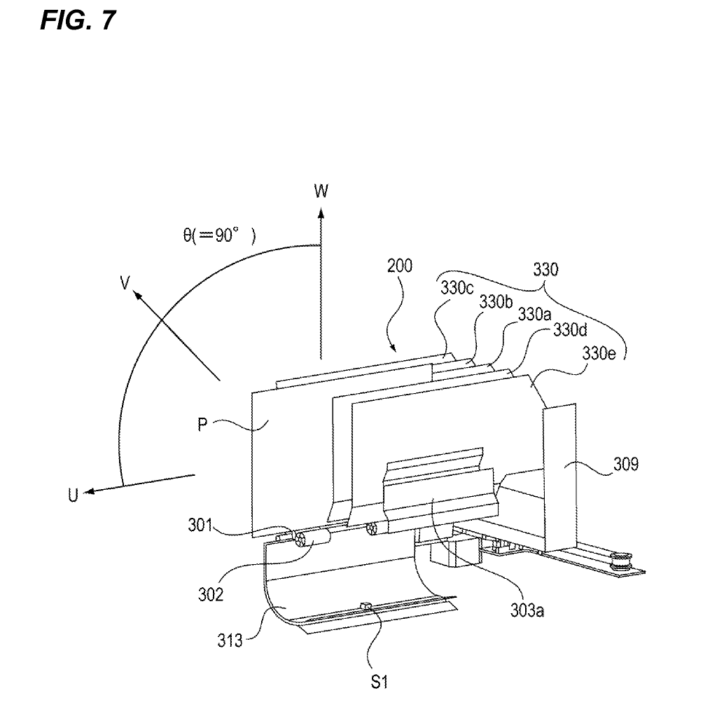

FIG. 7 is a perspective view illustrating a sheet P state held in the trays 330. As illustrated in FIG. 7, the holding portion 200 is arranged at an internal position of a width (extraction) direction perpendicular to the sheet conveying direction of the conveying guide 313 with respect to the conveyed sheet P. Therefore, when the sheet is held by the storage holding portion 200, one end of the sheet P in the width direction perpendicular to the sheet conveying direction protrudes to the front side of the extraction direction from the trays 330, that is, the front side of the apparatus main body.

The length of (the holding portion 200) of the trays 330 in the height direction is set such that the upper part of the stored sheet P protrudes. That is, in the present embodiment, the width of the trays 330 in the height and depth direction is set such that the downstream end in the sheet conveying direction and one end in the width direction of the stored sheet protrude from the trays 330. Therefore, the sheet P stored in the trays 330 can be extracted in the front direction U of the apparatus main body, the front-side obliquely upward direction V of the apparatus main body and the upward direction W denoted by an angle θ (=90°) of FIG. 7. Since the sheet P protrudes to the upper side and the front side of the trays 330 when being stored in the trays 330, the protrusion part is used as a grab margin when extracting the sheet P. When bundle of sheets P is extracted in the front direction of the apparatus main body, the front-side obliquely upward direction of the apparatus main body and the upward direction denoted by arrow A of FIG. 6A, the wedge effect of the holding member 305 is not obtained. Accordingly, it is possible to readily extract a sheet P or a bundle of sheets from the trays 330 with one hand. Further, the above description has been made in connection with the configuration about which both of the end portion of the sheet at the downstream side in the sheet conveying direction and one end of the sheet in the width direction protrude from the tray 330. However, when at least one of the end portion of the sheet at the downstream side in the sheet conveying direction and one end of the sheet in the width direction protrudes from the tray 330, extractability and visibility of the sheet can be improved.

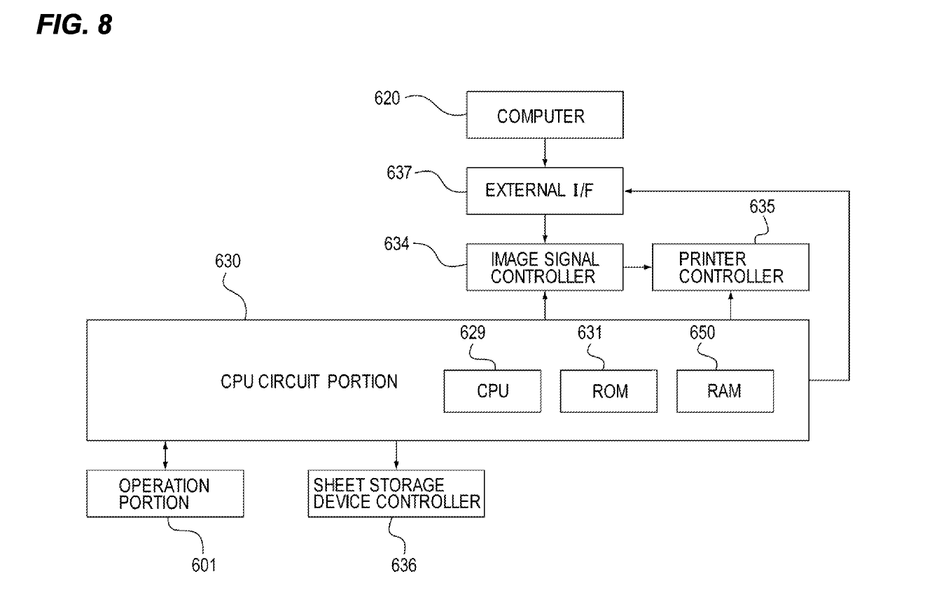

In addition, FIG. 8 is a control block diagram illustrating control of the image forming apparatus main body 100A and the sheet storage device 300. As illustrated in FIG. 8, the CPU circuit portion 630 includes a CPU 629, ROM 631 and RAM 650. The CPU circuit portion 630 controls an image signal controller 634, a printer controller 635, a sheet storage device controller 636, and an external interface 637 which is an interface with an external PC 602. In addition, the CPU circuit portion 630 controls the sheet storage device controller 636 according to a program stored in the ROM 631 and settings of an operation portion 601 mounted on an upper surface of the sheet storage device 300 as illustrated in FIG. 1.

The image signal controller 634 inputs image data, which is received from the external PC 602 through the external interface 637, to the printer controller 635 and the printer controller 635 controls the image forming apparatus main body 100A based on this image data. In addition, the sheet storage device controller 636 is mounted in the sheet storage device 300 to control the driving of the overall sheet storage device by exchanging information with the CPU circuit portion 630. In addition, although, in the present embodiment, the sheet storage device controller 636 is mounted in the sheet storage device 300, the present invention is not limited thereto. The sheet storage device controller 636 may be provided in the image forming apparatus main body 100A integrally with the CPU circuit portion 630 to control the sheet storage device 300 from the image forming apparatus main body side.

The sheet storage device controller 636 includes a CPU 701, RAM 702, ROM 703 and a storage portion controller 708, as illustrated in FIG. 9. The sheet storage device controller 636 communicates with the CPU circuit portion 630 mounted in the image forming apparatus main body through a communication interface 706 so as to perform data exchange. The sheet storage device controller 636 executes a variety of programs stored in the ROM 703 based on an instruction of the CPU circuit portion 630 and controls the sheet storage device 300 through the storage portion controller 708.

In order to perform sheet storage processing control, detection signals from various sensors to control the sheet storage device 300 are input from the storage portion controller 708 to the CPU 701 through an I/O 705. In addition, the various sensors include the above-described inlet sensor S1, a sheet presence/absence detection sensor S2 and a storage portion movement detection sensor S3. The CPU 701 drives the above-described conveying motor M1 and the storage portion moving motor M2 through the storage portion controller 708.

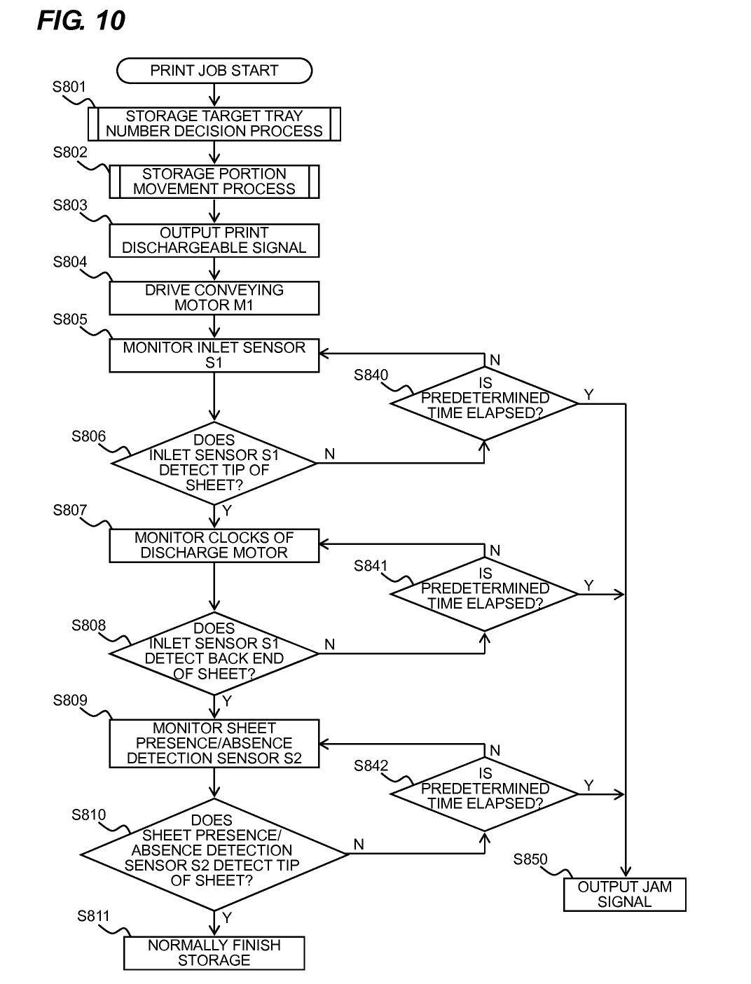

Next, sheet storage operation control of the sheet storage device 300 according to the present embodiment will be described with reference to FIG. 10. When a print job is sent to the image forming apparatus 100, the print job is started and thus the sheet storage device controller 636 first performs a storage target tray number decision process in step S801.

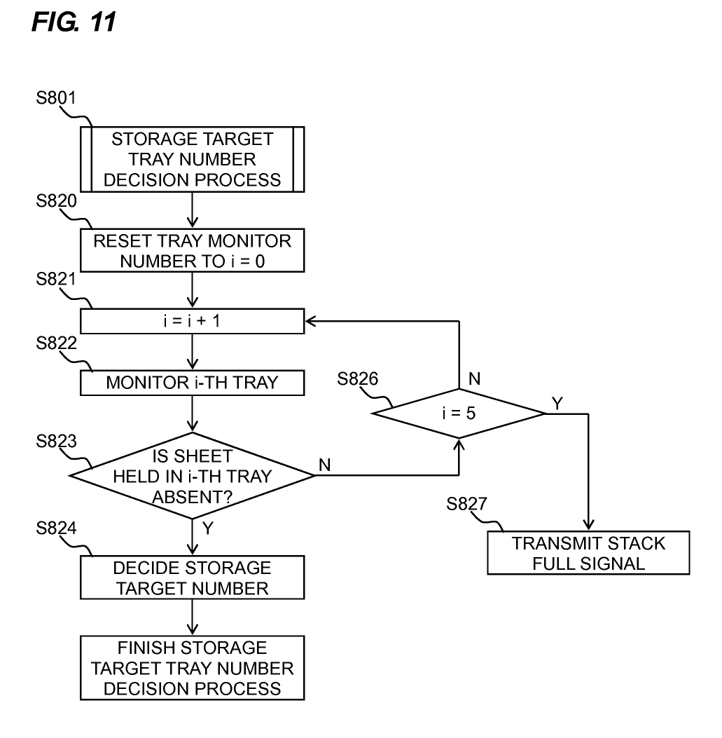

Then, as the storage target tray number decision process, as illustrated in FIG. 11, first, a tray monitor number i setting a tray storing the sheet is reset to 0 (i=0) in step S820 and a process of adding 1 to the tray monitor number i is then performed in step S821. Next, the i-th (=1) tray is monitored in step S822 and the sheet presence/absence detection sensor S2 determines whether a sheet held in the i-th (=1) tray is present in step S823.

Here, if the sheet held in the i-th (=1) tray is present (No in step S823), a determination is made whether i is 5, that is, the tray is the last tray in step S826. If i is not 5 (No in step S826), 1 is added to the tray monitor number i in step S821 and a determination is made whether the sheet held in the i-th (=2) tray is present in step S823.

In this way, if the sheet held in the tray (No in step S823), the process is repeatedly performed until the monitoring of the fifth tray is finished, that is, until i=5. If the sheet held in the fifth tray is present, that is, in the case of i=5 which is the case in which the sheets are held in all trays (Yes in step S826), a “stack FULL” signal is transmitted from the CPU 701 to the CPU circuit portion 630 in step S827. In addition, if the “stack FULL” signal is received, the CPU circuit portion 630 displays storage impossibility on a display portion (not illustrated) mounted in the operation portion 601.

Meanwhile, if the sheet held in the i-th tray is not present (absent) (Yes in step S823), the storage target number is decided to i in step S824. By deciding the storage target number, a conveying instruction to a tray having a storage target number of i is output and the storage target tray number decision process is finished.

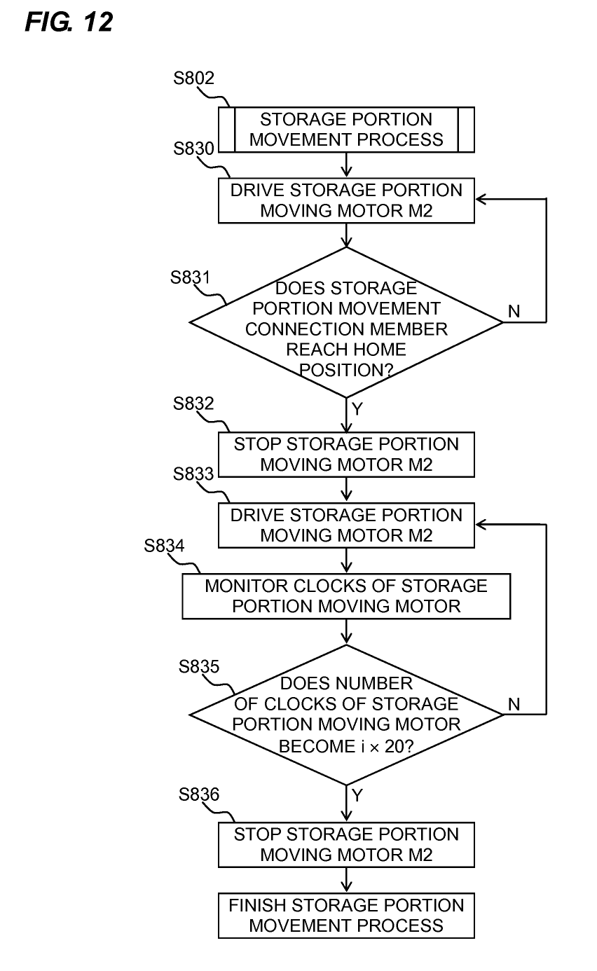

Next, if the storage target tray number decision process is finished, the process proceeds to the movement process illustrated in FIG. 10 in step S802. Then, as the storage portion movement process, as illustrated in FIG. 12, first, the storage portion moving motor M2 is driven in step S830 and the connection member 310 is moved to the home position illustrated in FIG. 2. Then, if the detection sensor S3 detects that the storage portion movement connection member 310 reaches the home position in step S831, that is, if the trays 330 reach the home position, the moving motor M2 is stopped in step S832.

Next, after the trays 330 reach the home position, the moving motor M2 is driven in step S833 and the number of clocks of the moving motor M2 is counted (monitored) in step S834. The number of clock of the moving motor M2 is counted until the i-th tray of the trays 330 decided by the storage target tray number decision process in step S801 described above reaches the position corresponding to the conveying roller 301. Then, if the number of clocks of the moving motor M2 becomes a predetermined number (i×20) in which the i-th tray reaches the position corresponding to the conveying roller 301 (Yes in step S835), the moving motor M2 is stopped in step S836.

Next, if such a movement process is finished, a print dischargeable signal is output to the CPU circuit portion 630 mounted at the image forming apparatus main body side as illustrated in FIG. 10 in step S803. In addition, the conveying motor M1 is driven in step S804 and arrival of the sheet is monitored by the inlet sensor S1 in preparation for the conveyance of the sheet from the image forming apparatus 100 in step S805. If the inlet sensor S1 detects a tip of the sheet (Yes in step S806), monitoring of the clock of the discharge motor is started in step S807.

Thereafter, if the inlet sensor S1 detects a back end of the sheet (Yes in step S808), the signal of the detection sensor S2 is monitored in step S809. If the detection sensor S2 detects the tip of the sheet (Yes in step S810), it is determined that the sheet is properly held in the storage holding portion 200 of the selected i-th tray 330 and it is determined that the storage of the sheet is normally finished in step S811.

If the inlet sensor S1 does not detect the tip of the sheet (No in step S806) and this state continues for a predetermined time (Yes in step S840), a jam signal is output in step S850. In addition, if the inlet sensor S1 does not detect the back end of the sheet (No in step S808) and this state continues for a predetermined time, that is, if the number of clocks of the motor becomes a predetermined value (Yes in step S842), the jam signal is output in step S850. In addition, if the sheet presence/absence detection sensor S2 does not detect the tip of the sheet (No in step S810 and this state continues for a predetermined time, that is, if the number of clocks of the motor becomes a predetermined value (Yes in step S841), the jam signal is output in step S850.

As described above, in the present invention, when the sheet is stored in the trays 330, the downstream end in the sheet conveying direction and one end in the width direction of the sheet protrude from the storage holding portion 200. Therefore, since the storage positions are not different in height, even when the sheet is stored in any of the five trays, it is possible to improve extractability and visibility. In addition, it is possible to extract a sheet without disarranging other stored sheets. That is, in the present embodiment, since the downstream end in the sheet conveying direction and one end in the width direction of the sheet stored in the trays 330 protrude from the trays 330, it is possible to improve extractability and visibility.

In addition, although, in the present embodiment, the sheet storage device 300 is mounted such that one end in the width direction of the sheet stored in the trays 330 protrudes to the front side of the image forming apparatus main body, the present invention is not limited thereto. For example, even when the sheet storage device may be mounted in a direction rotating from the mounting direction of the present embodiment by 90 degrees such that the image surface of the sheet stored in the tray 330 appears at the front side of the image forming apparatus main body, it is possible to improve extractability and visibility.

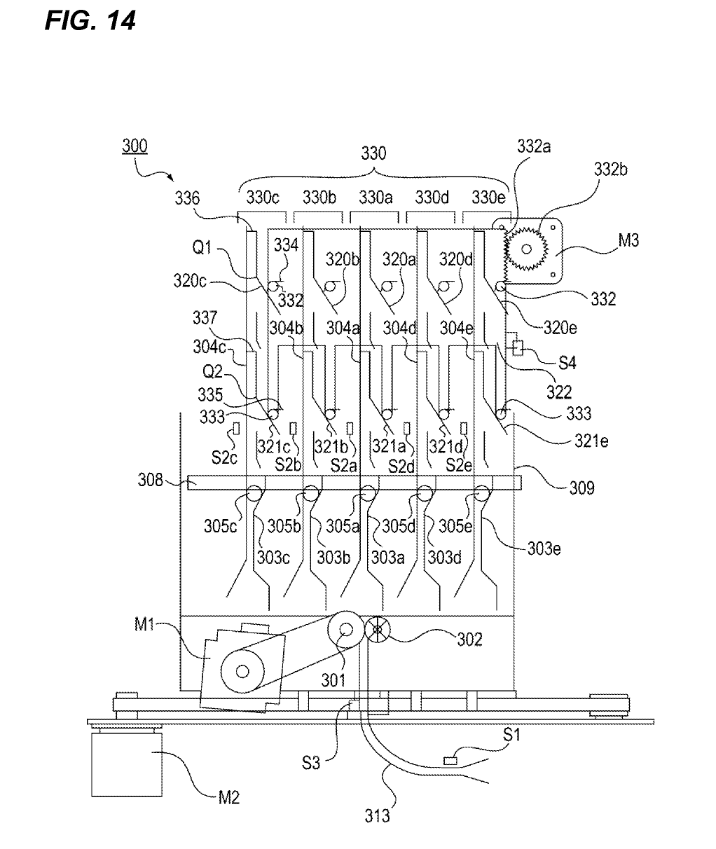

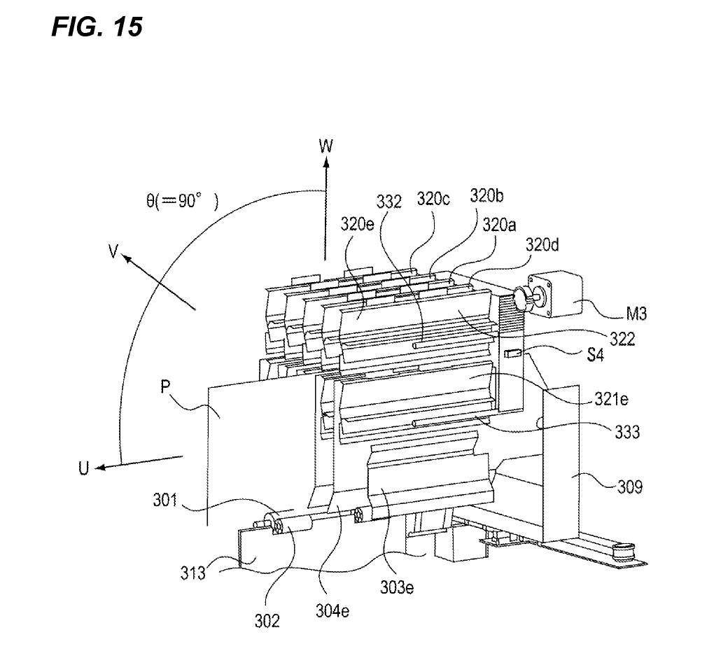

Next, a second embodiment of the present invention will be described. FIGS. 14 and 15 are diagrams illustrating the configuration of the sheet storage device according to the present embodiment. In addition, in FIGS. 14 and 15, the same reference numerals as FIGS. 2 and 7 denote the same or similar parts.

In FIGS. 14 and 15, lower tip stoppers 321 (321a to 321e) are provided above the sheet presence/absence detection sensor S2 of the tray 330 and upper tip stoppers 320 (320a to 320e) are provided above the lower tip stoppers 321. The upper and lower tip stoppers 320 and 321 are provided according to the sheet conveying direction length of the sheet.

Abutting parts 336 and 337 which abut on the tip of the sheet carried into the tray 330 from the lower part thereof to match the tip of the sheet are provided on the upper ends of the plurality of upper and lower tip stoppers 320 and 321 provided in a vertical direction. By providing the upper and lower tip stoppers 320 and 321 according to the sheet conveying direction length of the sheet, it is possible to align the positions of the tips of the sheets stored in the tray 330 and to improve a storage property.

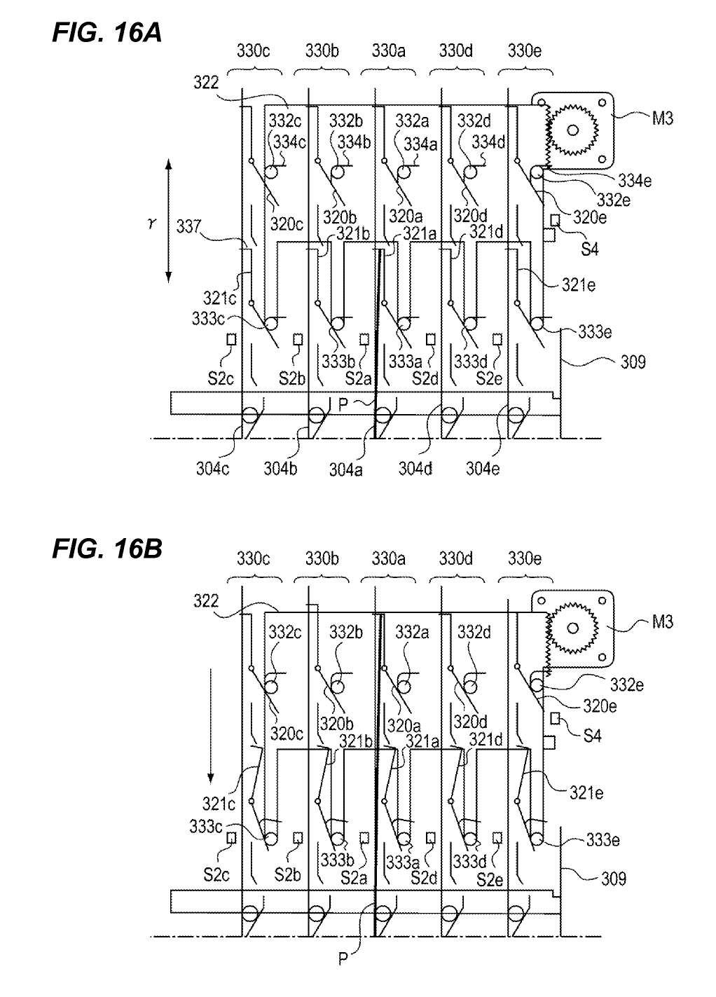

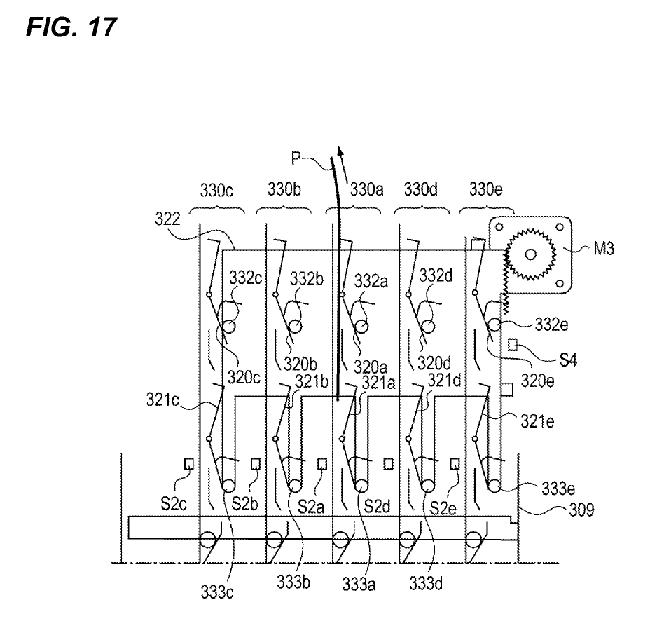

The upper and lower tip stoppers 320 and 321 can vibrate using shafts Q1 and Q2 mounted at positions of the storage guide 304 which do not impede sheet conveying as a support point. The upper and lower tip stoppers 320 and 321 vibrate, and the abutting parts 336 and 337 are fitted into the storage guide 304 and moved to matching positions where the tips of the sheet match and the below-described positions separated from the storage guide 304 illustrated in FIGS. 16A, 16B and 17.

Movement shafts 332 are locked to engaging parts 334 of the upper tip stoppers 320 and movement shafts 333 are locked to engaging parts 335 of the lower tip stoppers 321. These movement shafts 332 and 333 are fixed to a moving member 322.

The moving member 322 is vertically movable by a spur gear 332b of the moving motor M3 arranged to engage with a rack part 332a. By vertically moving the moving member 322, the movement shafts 332 and 333 are vertically moved to press the low ends of the upper and lower tip stoppers 320 and 321.

The upper and lower tip stoppers 320 and 321 vibrate using the shafts Q1 and Q2 as the support point such that the abutting parts 336 and 337 are separated from the storage guide 304. In the present embodiment, a movement portion that moves the upper and lower tip stoppers 320 and 321 includes the movement shafts 332 and 333, the moving member 322 and the moving motor M3. In addition, the stop position of the moving member 322 is controlled by the detection sensor S3.

Timing when the lowered movement shaft 333 is brought into contact with the lower end of the lower tip stopper 321 is shorter than timing when the lowered movement shaft 332 is brought into contact with the lower end of the upper tip stopper 320. The lower tip stopper 321 vibrates earlier than the upper tip stopper 320 and the abutting part 336 of the lower tip stopper 321 is separated from the storage guide 304 earlier than the abutting part 337 of the upper tip stopper 320. As a result, as described below, when a sheet having a large size is stored, the sheet can be brought into contact with the upper tip stopper 320 without impending of the lower tip stopper 321.

In addition, even in the present embodiment, the sheet can be extracted in the front direction U of the apparatus main body, the front-side obliquely upward direction V of the apparatus main body and the upward direction W as illustrated in FIG. 15. When the sheet P is extracted in the W direction, since the upper and lower tip stoppers 320 and 321 are moved to positions where the abutting parts 336 and 337 are separated from the storage guide 304 as illustrated in FIG. 17, it is possible to extract the sheet P upward.

Next, an operation of storing and holding the sheet P in the storage holding portion 200 of the tray 330 will be described with reference to FIGS. 16A and 16B. FIG. 16A is a diagram illustrating a state when a sheet having a small size is stored. At this time, the contact portion 337 of the lower tip stopper 321 is fitted into the storage guide 304 so as to position the tip of the sheet. The movement height of the moving member 322 is controlled such that the lower tip stopper 321 is positioned at such a position.

FIG. 16B is a diagram illustrating a state when a sheet having a large size is stored. At this time, the lowered movement shaft 333 is brought into contact with the lower end of the lower tip stopper 321, but the movement shaft 332 is not brought into contact with the lower end of the upper tip stopper 320. Therefore, the abutting part 336 of the upper tip stopper 320 is fitted into the storage guide 304 at a position where the abutting part 337 of the lower tip stopper 321 is separated from the storage guide 304.

The movement height of the moving member 322 is controlled such that the upper and lower tip stoppers 320 and 321 are positioned at such positions.

FIG. 17 is a diagram illustrating a state when the sheet P stored in the holding portion 200 of the tray 330 is extracted. In this case, the abutting parts 336 and 337 of the upper and lower tip stoppers 320 and 321 are positioned at positions separated from the storage guide 304. The movement height of the moving member 322 is controlled such that both the upper and lower tip stoppers 320 and 321 are positioned at such positions. Accordingly, the sheet P may be extracted while passing through the upper tip stopper 320.

In the present embodiment, by controlling the position of the moving member 322, it is possible to control the positions of the upper and lower tip stoppers 320 and 321. In addition, if the moving member 322 is lifted after the sheet appears, the engaging parts 334 and 335 of the upper and lower tip stoppers 320 and 321 are engaged with the upper and lower tip stopper movement shafts 332 and 333. Thus, when the moving member 322 is further lifted, the upper and lower tip stoppers 320 and 321 return to matching positions where the tips of the sheet match as illustrated in FIG. 16A.

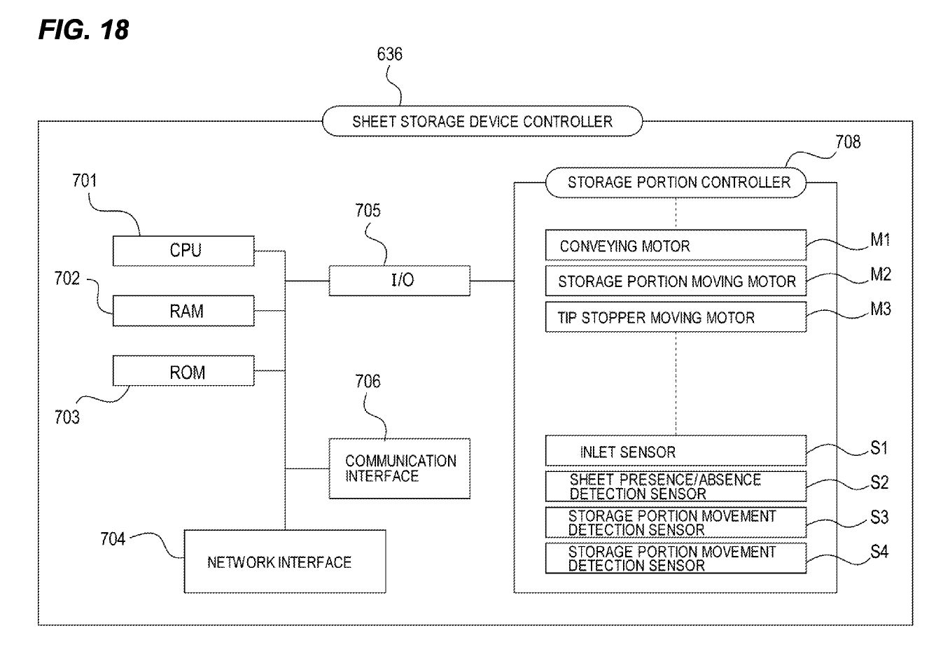

FIG. 18 is a control block diagram illustrating control of the sheet storage device controller 636 according to the present embodiment. In FIG. 18, the same reference numerals as FIG. 9 denote the same or similar parts. As illustrated in FIG. 18, the sheet storage device controller 636 controls the sheet storage device 300 through the storage portion controller 708. For the control of the sheet storage processing, detection signals from various sensors are input from the storage portion controller 708 to the CPU 701 through an I/O 705 to control the sheet storage device 300.

In addition, the various sensors include the above-described inlet sensor S1, a detection sensor S2 detecting presence/absence of sheet, a detection sensor S3 detecting the movement of a storage portion, and a detection sensor S4 detecting movement of the tip stopper. The CPU 701 drives the above-described conveying motor M1, the moving motor M2 moving the storage portion and the moving motor M3 moving the tip stopper through the storage portion controller 708.

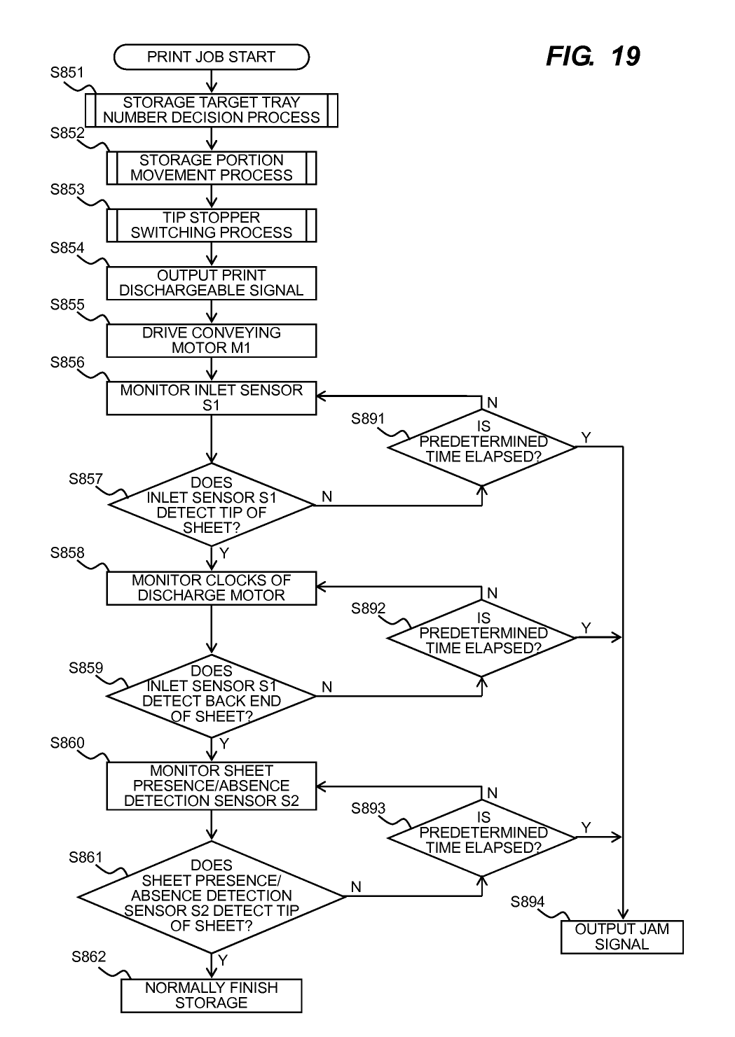

Next, sheet storage operation control of the sheet storage device 300 according to the present embodiment will be described with reference to FIG. 19. When a print job is sent to the image forming apparatus 100, the print job is started and thus the sheet storage device controller 636 first performs a storage target tray number decision process illustrated in FIG. 11 in step S851. Thereafter, the storage portion movement process illustrated in FIG. 12 is performed in step S852.

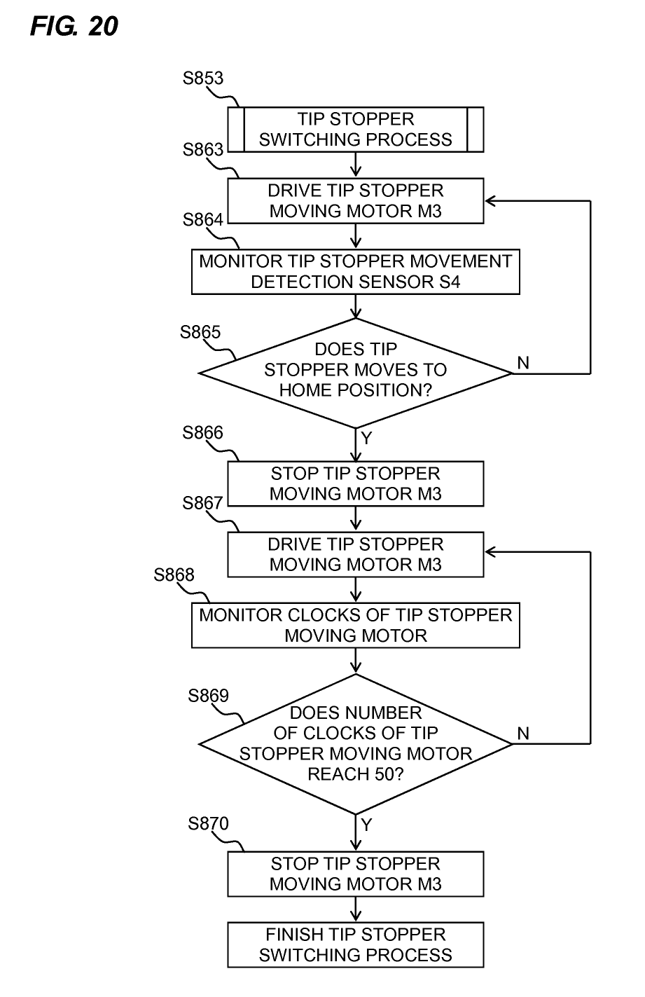

Next, a tip stopper conversion process is performed such that the positions of the upper and lower tip stoppers 320 and 321 are changed according to the size of a conveyed sheet P in step S853. As the tip stopper conversion process, as illustrated in FIG. 20, first, the moving motor M3 is driven such that the moving member 322 returns to, for example, the home position illustrated in FIG. 14 in step S863.

Next, the detection sensor S4 is monitored in step S864 and the detection sensor S4 detects whether the moving member 322 moves to the home position in step S865. If the moving member 322 is detected to be moved to the home position by a signal from the detection sensor S4 (Yes in step S865), the moving motor M3 is stopped in step S866.

Next, the moving member 322 is lowered and the moving motor M3 is driven such that the upper and lower tip stoppers 320 and 321 are moved to positions according to the size of the stored sheet P in step S867. Then, the number of clocks of the moving motors M3 is monitored in step S868 and, if the number of clocks reaches a predetermined clock number (=50) (Yes in step S869), the moving motor M3 is stopped in step S870.

Thus, the positions of the upper and lower tip stoppers 320 and 321 become positions illustrated in FIG. 16A if a sheet having a small size is stored and become positions illustrated in FIG. 16B if a sheet having a large size is stored. By switching the positions of the upper and lower tip stoppers 320 and 321 to such positions, a switching process of switching the tip stoppers is finished.

Next, if such a storage portion movement process is finished, a print dischargeable signal is output to the CPU circuit portion 630 mounted at the image forming apparatus main body side as illustrated in FIG. 19 in step S854. In addition, the conveying motor M1 is driven in step S855 and arrival of the sheet is monitored by the inlet sensor S1 in preparation for the conveyance of the sheet from the image forming apparatus 100 in step S856. If the inlet sensor S1 detects a tip of the sheet (Yes in step S857), monitoring of the clock of the discharge motor is started in step S858.

Thereafter, if the inlet sensor S1 detects a back end of the sheet (Yes in step S859), the signal of the detection sensor S2 is monitored in step S860. If the detection sensor S2 detects the tip of the sheet (Yes in step S861), it is determined that the sheet is normally held in the storage holding portion 200 of the tray 330 and it is determined that the print job is normally finished in step S862.

If the inlet sensor S1 does not detect the tip of the sheet (No in step S857) and this state continues for a predetermined time (Yes in step S891), a jam signal is output in step S894. In addition, if the inlet sensor S1 does not detect the back end of the sheet (No in step S859) and this state continues for a predetermined time, that is, if the number of clocks of the motor becomes a predetermined value (Yes in step S892), the jam signal is output in step S894. In addition, if the sheet presence/absence detection sensor S2 does not detect the tip of the sheet (No in step S861) and this state continues for a predetermined time, that is, if the number of clocks of the motor becomes a predetermined value (Yes in step S893), the jam signal is output in step S894.

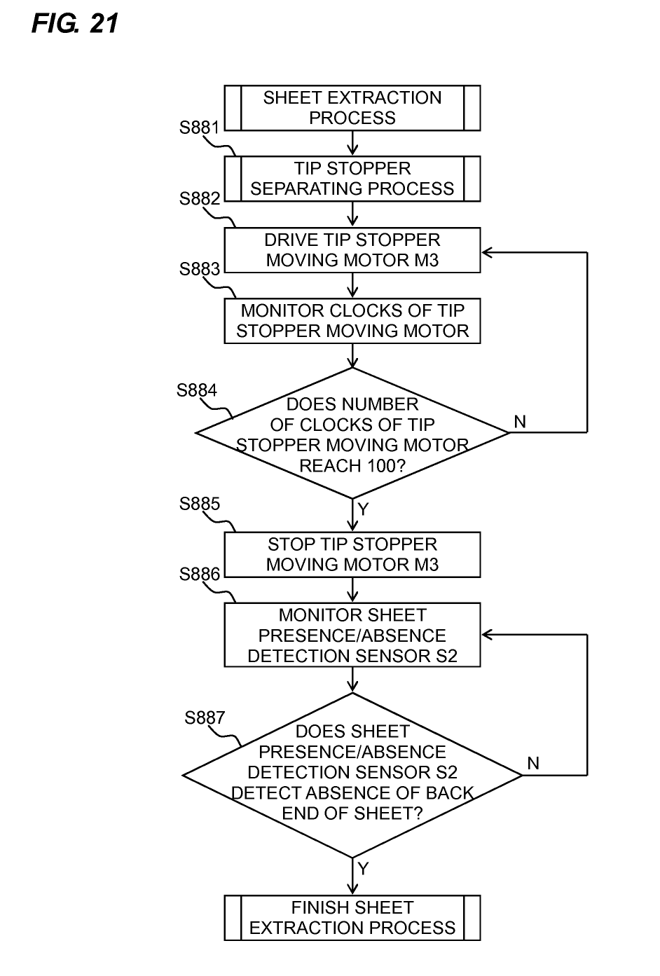

Next, a sheet extraction process of normally extracting a sheet held in the holding portion 200 of the tray 330 will be described with reference to FIG. 21. In this process, first, a process of separating a tip stopper is started in step S881. Thus, the moving motor M3 is driven in step S882 and the moving member 322 is lowered. In addition, monitoring of the motor clocks of the moving motor M3 is started in step S883.

If the number of motor clocks of the moving motor M3 becomes a predetermined value (=100) (Yes in step S884), the moving motor M3 is stopped in step S885. In addition, the number of clocks of the tip stopper moving motor increases as compared to the above-described process of switching the tip stopper in step S853. Therefore, as illustrated in FIG. 17, the abutting parts 336 and 337 of the upper and lower tip stoppers 320 and 321 may be moved to positions separated from the storage guide 304, that is, extraction positions where a sheet can be extracted upward.

Next, in order to determine whether the sheet P is extracted from the tray 330, the sheet presence/absence detection sensor S2 is monitored in step S886 and, if the sheet presence/absence detection sensor S2 detects absence of the back end of the sheet P (Yes in step S867), it is determined that the sheet extraction process is normally finished.

As described above, in the present embodiment, the upper and lower tip stoppers 320 and 321 are provided in the tray 330 such that the positions of the upper and lower end stoppers 320 and 321 are changed at the time of a sheet storage operation and at the time of a sheet extraction operation. Accordingly, since the positions of the tips of the sheets stored in the tray 330 are aligned, it is possible to improve a storage property and extractability.

In addition, in the present embodiment, the movement shafts 332 and 333 of the trays 330 are collectively moved in a vertical direction by the moving motors M3. However, the present embodiment is not limited thereto and the moving motor M3 may be provided in each of the trays 330 such that the movement shafts 332 and 333 are independently operated.

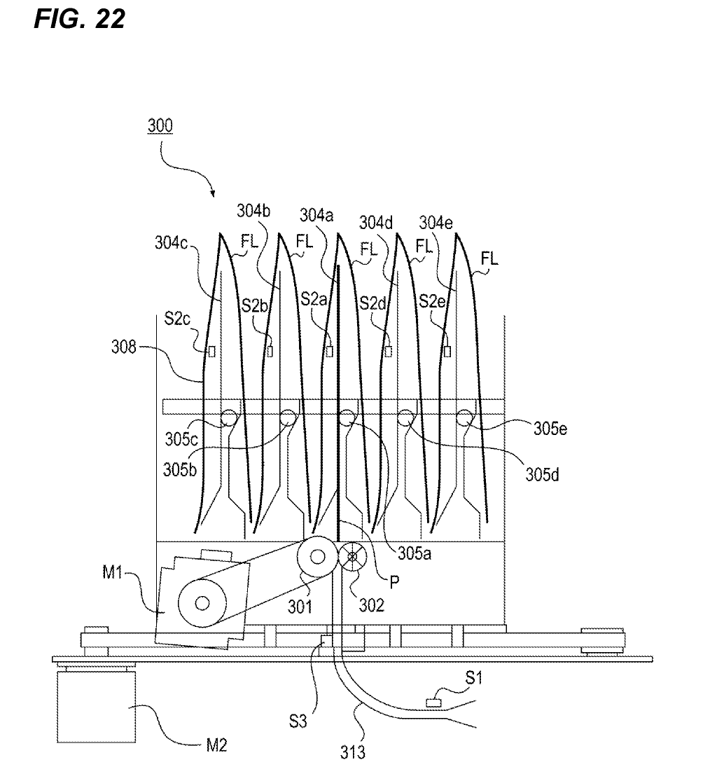

Next, a third embodiment of the present invention will be described. FIG. 22 is a diagram illustrating the configuration of a sheet storage device according to the present embodiment. In addition, in FIG. 22, the same reference numerals as FIG. 2 denote the same or similar parts.

In FIG. 22, a sheet storage file FL is a sheet reception medium and, in the present embodiment, and the sheet storage files FL cover the upper parts of the trays 330 from the upper sides of the five trays 330 (330a to 330e). The sheet P held in the storage holding portion 200 of the tray 330 is stored in the sheet storage file FL.

Here, the sheet storage file FL generally stores a bundle of sheets and is a conveyable/movable pocket-shaped file formed of thin resin having opened two sides or three sides. If the sheet storage file FL is set, as illustrated in FIG. 22, a closed side of the sheet storage file FL is set to be positioned on the upper end of the storage guide 304. In addition, in the present embodiment, this sheet storage file FL is formed of a translucent material. By forming the sheet storage file FL using a translucent material, the sheet presence/absence detection sensor S2 can detect the sheet P conveyed into the sheet storage file FL without detecting the sheet storage file FL.

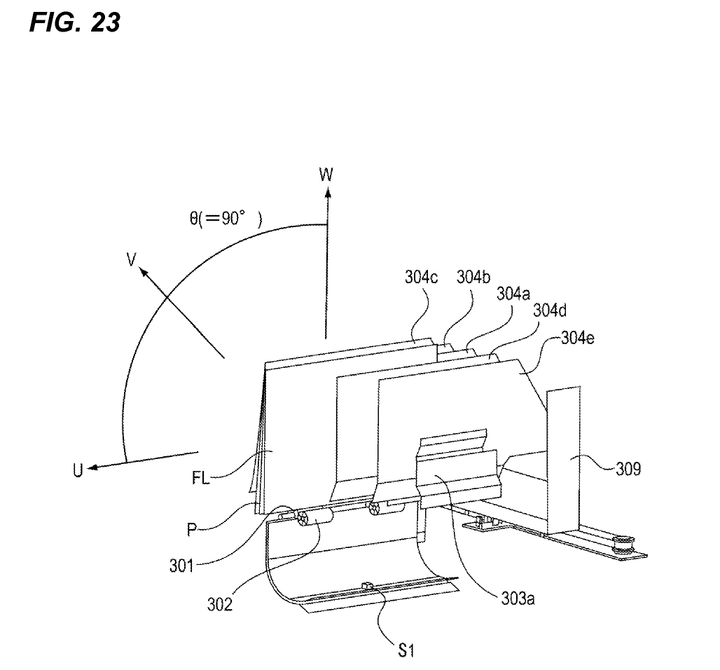

Even in the present embodiment, as illustrated in FIG. 23, one end in the width direction of the sheet P protrudes from the tray 330 when the sheet is held in the holding portion 200. Therefore, the direction in which the sheet storage file FL is extracted from the tray 330 is in a range of an angle 0 including U, V and W directions. Since the sheet storage file FL protrudes to the front side of the tray 330 in a state of being set, the protrusion part is used as a grab margin when extracting the sheet.

In addition, although, in the present embodiment, in particular, a detection sensor detecting whether the sheet storage file FL is set is not provided, a detection sensor may be provided in each of the trays 330a to 330e such that the sheet P is discharged to the tray 330 in which the storage file FL is set. If it is desired to increase confidentiality of the discharged sheet P, it is possible to prevent the content of the image of the sheet P held in the holding portion 200 from being viewed from the outside by setting a sheet storage file FL having low transparency in the tray 330.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2011-101453, filed Apr. 28, 2011, which is hereby incorporated by reference herein in its entirety.

What is claimed is:

1. A sheet storage device mounted above an image forming apparatus main body to store sheet sequentially conveyed from the image forming apparatus main body, the sheet storage device comprising:
a conveying portion configured to convey the sheet; and
a plurality of sheet storage portions configured to receive the sheet conveyed by the conveying portion from a low part thereof, and store the sheet in a standing state, each of the plurality of sheet storage portions includes:
a holding portion configured to hold the sheet so as to permit a sheet passing in a sheet conveying direction, and restrict a movement of the sheet in a direction opposite to the conveying direction, the holding portion holds the sheet such that at least one of a downstream end in the sheet conveying direction and one end in a width perpendicular to the sheet conveying direction of the stored sheet protrudes.

2. The sheet storage device according to claim 1, the holding portion includes:
a first guide member configured to form a sidewall of each of the sheet storage portions and guide the sheet conveyed from the lower part thereof;
a second guide member mounted to face the first guide member and configured to have a lower guide part configured to guide the sheet conveyed from the lower part thereof along with the first guide member and an inclination part located above the lower guide part and inclined in a direction distant from the first guide member; and
a holding member which is mounted between the first guide member and the second guide member, abuts on the first guide member and the inclination part of the second guide member by a weight thereof, is lifted by pressure of the sheet passing through an abutting part with the first guide member when the sheet is stored, is lowered if the pressure of the sheet is released, nips the sheet with the first guide member, and holds the sheet,
wherein heights of the first guide member and the second guide member and positions of one ends thereof in a width direction are set such that at least one of an end portion of the stored sheet at a downstream side in the sheet conveying direction and one end of the sheet in the width direction protrudes.

3. The sheet storage device according to claim 1, wherein the holding portion comprises:
a first guide member that configures a sidewall of the sheet storage portion and guides the sheet conveyed from the lower part thereof;
a second guide member that is mounted to face the first guide member and guides the sheet conveyed from the lower part thereof along with the first guide member; and
a holding member that abuts on the first guide member, runs idle on a fixed shaft fixed to the second guide member in a direction following the sheet conveyed upward, and is provided through a one-way clutch engaged with the fixed shaft in a reverse direction,
wherein heights of the first guide member and the second guide member and positions of one ends thereof in a width direction are set such that at least one of an end portion of the stored sheet at a downstream side in the sheet conveying direction and one end of the sheet in the width direction protrudes.

4. The sheet storage device according to claim 1, further comprising:
a stopper which is mounted above each of the sheet storage portions, abuts on the downstream end of the conveyed sheet in the sheet conveying direction, and is capable of moving to a matching position in which the position of the downstream end of the sheet in the sheet conveying direction matches and an extraction position in which the stored sheet is extracted upward; and
a movement portion configured to move the stopper to one of the matching position and the extraction position.

5. The sheet storage device according to claim 4, wherein a plurality of stoppers is provided in a vertical direction according to a length of the stored sheet in the sheet conveying direction and the movement portion moves the plurality of stoppers to the extraction position when the sheet is extracted upward.

6. The sheet storage device according to claim 1, wherein a sheet reception medium is applied to cover an upper part of the sheet storage portion from an upper side of the sheet storage portion such that the stored sheet is extracted in a state of being received in the sheet reception medium.

7. An image forming apparatus comprising:
an image forming apparatus main body forming an image on a sheet; and
a sheet storage device mounted above the image forming apparatus main body to store sheet sequentially conveyed from the image forming apparatus main body, the sheet storage device includes
a conveying portion configured to convey the sheet, and
a plurality of sheet storage portions configured to receive the sheet conveyed by the conveying portion from a low part thereof, store the sheet in a standing state, each of the plurality of sheet storage portions includes:
a holding portion configured to hold the sheet so as to permit a sheet passing in a sheet conveying direction of the conveying portion, and restrict a movement of the sheet in a direction opposite to the conveying direction, the holding portion holds the sheet such that at least one of a downstream end in the sheet conveying direction and one end in a width perpendicular to the sheet conveying direction of the stored sheet protrudes.

8. The image forming apparatus according to claim 7, the holding portion includes:
a first guide member configured to form a sidewall of each of the sheet storage portions and guide the sheet conveyed from the lower part thereof;
a second guide member mounted to face the first guide member and have a lower guide part configured to guide the sheet conveyed from the lower part thereof along with the first guide member and an inclination part located above the lower guide part and inclined in a direction distant from the first guide member; and
a holding member which is mounted between the first guide member and the second guide member, abuts on the first guide member and the inclination part of the second guide member by a weight thereof, is lifted by pressure of the sheet passing through an abutting part with the first guide member when the sheet is stored, is lowered if the pressure of the sheet is released, nips the sheet with the first guide member, and holds the sheet,
wherein heights of the first guide member and the second guide member and positions of one ends thereof in a width direction are set such that at least one of an end portion of the stored sheet at a downstream side in the sheet conveying direction and one end of the sheet in the width direction protrudes.

9. The image forming apparatus according to claim 7, wherein the holding portion includes:
a first guide member that configures a sidewall of the sheet storage portion and guides the sheet conveyed from the lower part thereof;
a second guide member that is mounted to face the first guide member and guides the sheet conveyed from the lower part thereof along with the first guide member; and
a holding member that abuts on the first guide member, runs idle on a fixed shaft fixed to the second guide member in a direction following the sheet conveyed upward, and is provided through a one-way clutch engaged with the fixed shaft in a reverse direction,
wherein heights of the first guide member and the second guide member and positions of one ends thereof in a width direction are set such that at least one of an end portion of the stored sheet at a downstream side in the sheet conveying direction and one end of the sheet in the width direction protrudes.

10. The image forming apparatus according to claim 7, further comprising:
a stopper which is mounted above each of the sheet storage portions, abuts on the downstream end of the conveyed sheet in the sheet conveying direction, and is capable of moving to a matching position in which the position of the downstream end of the sheet in the sheet conveying direction matches and an extraction position in which the stored sheet is extracted upward; and
a movement portion configured to move the stopper to one of the matching position and the extraction position.

11. The image forming apparatus according to claim 10, wherein a plurality of stoppers is provided in a vertical direction according to a length of the stored sheet in the sheet conveying direction and the movement portion moves the plurality of stoppers to the extraction position when the sheet is extracted upward.

12. The image forming apparatus according to claim 7, wherein a sheet reception medium is applied to cover an upper part of each of the sheet storage portions from an upper side of each of the sheet storage portions such that the stored sheet is extracted in a state of being received in the sheet reception medium.
